(19) United States
(12) Patent Application Publication
(10) Pub. No.: US 2022/0350008 A1
(43) Pub. Date: Nov. 3, 2022

(54) RAILROAD CROSSING OBSTACLE DETECTION SYSTEM

(71) Applicant: DENSO WAVE INCORPORATED, Chita-gun (JP)

(72) Inventors: Yuta FUKUDA, Chita-gun (JP); Kunihiko ITO, Chita-gun (JP)

(73) Assignee: DENSO WAVE INCORPORATED, Chita-gun (JP)

(21) Appl. No.: 17/722,880

(22) Filed: Apr. 18, 2022

(30) Foreign Application Priority Data
Apr. 28, 2021 (JP) 2021-076741

(51) Int. Cl. G01S 13/10; G01S 13/62

(52) U.S. Cl. CPC G01S 13/103; G01S 13/62

(57) ABSTRACT

A railroad crossing obstacle detection system including: a laser radar device that includes an irradiator and a light receiver, the irradiator applying laser light at irradiation angles set every prescribed angle, and the light receiver receiving the laser light reflected; and a controller, wherein the laser radar device is configured to be supported by an object such that the laser radar device is located above a detection area of an obstacle in railroad crossing, and to apply the laser light from above to the detection area, and the controller is configured to detect an obstacle on the basis of measurement result representing a distance to an object having reflected the laser light, and an irradiation angle for the object; and monitor a change of at least one of a position or a direction of the laser radar device on the basis of the measurement result by the laser radar device.

### CROSS-REFERENCE TO RELATED APPLICATION

This application is based on and claims the benefit of priority from earlier Japanese Patent Application No. 2021-076741 filed on Apr. 28, 2021, the description of which is incorporated herein by reference.

### BACKGROUND OF THE INVENTION

### Technical Field of the Invention

The present disclosure relates to a railroad crossing obstacle detection system.

### Related Art

As a railroad crossing obstacle detection system that detects an obstacle such as a vehicle stuck in a railroad crossing, there is one including a scan-type laser radar device that applies laser light parallel with the ground. In this type of railroad crossing obstacle detection system, a laser radar device is disposed at a low position close to the ground, for example, a location lower than a gate arm of a crossing gate. Such a disposition of the laser radar device prevents an obstacle such as a human or a vehicle from not being detected (for example, see Japanese Patent Laid-open Publication No. 11-227608).

### SUMMARY

When the laser radar device is disposed at a low position close to the ground as described above, there is a concern that the light path of laser light may be blocked due to influence of weather or the like, causing problems in exhibiting the function of applying the laser light to a detection area. For example, the application of laser light to a detection area is likely to be inhibited by snow coverage or by the laser radar device being soiled with splashes of mud when a vehicle passes by. The occurrence of such a phenomenon is not preferred, to increase the reliability of the railroad crossing obstacle detection system.

Here, the inventors of the present disclosure have designed a configuration in which a laser radar device is disposed at a high position using a support such as a pole, and laser light is applied from above to a detection area. Such a configuration can suitably prevent the inhibition of the application of laser light to a detection area. However, the laser radar device that is disposed at a high position using a support object such as a pole is highly likely to be greatly changed in position or direction when the support object is distorted due to an external factor such as strong wind or earthquake, compared to the laser radar device disposed at a low position. In addition, there are fewer shielding constructions in the vicinity of a railroad crossing, and therefore the laser radar device is blown by strong wind, possibly causing deformation or the like of a fitting (attachment) of the laser radar device. Thus, the laser radar device may be changed in position or direction. The change in position or direction of the laser radar device becomes a factor of deviating the irradiation region of laser light (making the irradiation region out of the proper position). Such a deviation of the irradiation region carries a risk of causing obstacles to be not detected and inhibits the increase of the reliability of the railroad crossing obstacle detection system. Thus, in order to increase the reliability of the railroad crossing obstacle detection system, there is still room for improving the configuration thereof.

The present disclosure has been made in view of the problems described above, and a main objective of the present disclosure is to increase the reliability of the railroad crossing obstacle detection system.

Hereinafter, aspects for solving the problems are described.

A railroad crossing obstacle detection system comprising:

a laser radar device that includes an irradiator and a light receiver, the irradiator applying laser light at irradiation angles set every prescribed angle, and the light receiver receiving the laser light reflected; and

a controller, wherein

the laser radar device is configured to be supported by a support object such that the laser radar device is located above a detection area of an obstacle in a railroad crossing, and to apply the laser light from above to the detection area, and

the controller is configured to:

detect an obstacle located in the detection area on the basis of a measurement result representing a distance to an object having reflected the laser light, and an irradiation angle for the object; and

monitor a change of at least one of a position or a direction of the laser radar device on the basis of the measurement result by the laser radar device.

The laser radar device configured to be disposed at a high position using the support object (e.g., a pole) and to apply the laser light from above to the detection area is more advantageous than the laser radar device configured to be disposed at a low position close to the ground and horizontally apply the laser light, to prevent the light path of the laser light from being blocked due to the influence of weather or the like, that is, to prevent problems in exhibiting the function of applying the laser light to the detection area.

On the other hand, the laser radar device that is disposed at a high position using the support object is highly likely to be changed in position or direction due to an influence of strong wind, earthquake, or the like, and there is a concern that deviation of the irradiation region of laser light (easily make the irradiation region out of the proper position) may easily occur. However, the railroad crossing obstacle detection system according to an embodiment of the present disclosure monitors a change of at least one of the position or the direction of the laser radar device on the basis of the measurement result by the laser radar device and can thereby recognize, with a simple configuration, a situation in which the laser light cannot be applied to the proper position. That is, the railroad crossing obstacle detection system is configured to apply the laser light from above to the detection area and to monitor a change of at least one of the position or the direction of the laser radar device, and can thereby suitably increase the reliability thereof.

The railroad crossing obstacle detection system comprises a reference object disposed in an irradiation region of laser light, wherein

the controller includes a memory that stores, as reference information, information on a distance to the reference object and an irradiation angle for the reference object, or area information defined on the basis of the information, and determines a change of at least one of a position or a direction of the laser radar device on the basis of the reference information stored in the memory and the measurement result.

The railroad crossing obstacle detection system is configured to monitor a change of at least one of the position or the direction of the laser radar device using the reference object disposed in the irradiation region of laser light. The railroad crossing obstacle detection system can thereby realize a self-monitoring function with a simple configuration.

The reference object is disposed at a position around the laser radar device and lower than a position of the laser radar device.

In the railroad crossing obstacle detection system configured to apply the laser light from above to the detection area, disposing the reference object at a position lower than the position of the laser radar device can prevent unnecessary broadening of the irradiation region. Compared to disposing the reference object at a low position, disposing the reference object around the laser radar device and at a high position can make the railroad crossing obstacle detection system less likely to suffer inconvenience such as inhibition of the application of the laser light to the reference object due to an influence of snow coverage or the like. In addition, disposing the reference object around the laser radar device is preferred to prevent the transmission of laser light from application through reflection to reception between the reference object and the laser radar device from being inhibited.

The laser radar device is configured to scan the irradiation region by applying a laser light to acquire the measurement result, and

the reference object is disposed at a position on a light path of a laser light applied at start angle or end angle in a detection range which is a part of a scan cycle or at a position adjacent to the light path, the laser light being applied in the scan cycle, and the position adjacent to the light path being outside of the detection area.

The reference object is disposed at a position on the light path of laser light applied to an edge of the detection area in the scan cycle or at a position adjacent to the light path. Such a disposition can prevent the reference object from inhibiting the obstacle detection or inhibiting widening of the detection area even when the reference object is disposed around the laser radar device.

The reference object is disposed on an other support object different from the support object that supports the laser radar device.

In the case that the laser radar device and the reference object are disposed on the same object, the positional relationship between the detection area or irradiation area and the reference object may not change due to a change of the position of the reference object even when the position or the direction of the laser radar device changes due to deformation of the support object. In this case, a change in position or direction of the laser radar device may cause may not be detected. However, disposing the laser radar device and the reference object on respective support objects makes it possible that the positional relationship easily changes when the support objects for the laser radar device deforms. Therefore, it is possible to prevent a change in position or direction of the laser radar device from not being detected.

The detection area of the laser radar device extends along a road intersecting a railroad in the railroad crossing, and

both the support object and the other support object are poles that are disposed in to be mutually parallel along the road.

Setting the detection area so as to extend along a road can suitably prevent obstacles from not being detected. In this case, by arranging the poles along a road, it is possible to dispose the laser radar device and the reference object efficiently.

The reference object is attached to the support object that supports the laser radar device using an attachment different from an attachment for the laser radar device.

The configuration for attaching both the laser radar device and the reference object to one support object is preferred to simplify the detection system. In such a configuration, as an attachment for the reference object, the attachment different from an attachment for the laser radar device is used. Thereby the positional relationship between the detection area or irradiation area of the laser radar device and the reference object can easily change when the attachment for the laser radar device deforms. Therefore, it is possible to prevent a change in position or direction of the laser radar device from not being detected.

The support object is a pole, and

the reference object and the laser radar device viewed in a longitudinal direction of the pole are positionally offset from each other in a peripheral direction of the pole.

Even if the attachment for one of the laser radar device or the reference object, whose position is higher than the other, is inclined downward due to deformation of its attachment, it is possible to prevent it from, for example, pushing the other and thus the other from also being inclined downward. Such a configuration can therefore prevent the positional relationship between the detection area or irradiation area of the laser radar device and the reference object from being identical before and after deformation. Thus, it is possible to suitably reduce the risk of missing a change in position or direction of the laser radar device. In addition, the configuration for positionally shifting the laser radar device and the reference object in the peripheral direction of the pole easily makes the laser radar device and the reference object close to each other, compared to the configuration for distancing the laser radar device from the reference object in the longitudinal direction of the pole to prevent mutual interference. This configuration is preferred to realize a configuration for disposing the reference object around the laser radar device.

The railroad crossing is provided with a crossing gate, and the laser radar device is disposed at a position higher than a position of a gate arm of the crossing gate that is closed,

the detection area is set such that the gate arm is located in the detection area when the crossing gate is closed,

the memory stores, as gate arm information, first information on a distance to the gate arm and an irradiation angle for the gate arm when the crossing gate is closed, or second information relating to the first information, and

the controller monitors a motion of the gate arm on the basis of the gate arm information and the measurement result.

According to the above configuration, it is possible to check by the laser radar device whether the crossing gate is acting properly. This makes it possible to smoothly recognize a breakdown or the like of the crossing gate and to contribute to a further increase in safety of the railroad crossing.

The railroad crossing obstacle detection system comprises a reference object displaceable between a first position in the detection area and a second position out of the detection area, wherein

the reference object is located at the second position when a crossing gate of the railroad crossing is open, and the reference object is located at the first position when the crossing gate is closed, and

the controller includes a memory that stores, as reference information, first information on at least a distance to the reference object at the first position and an irradiation angle for the reference object, or second information relating to the first information, and determines a change of at least one of a position or a direction of the laser radar device on the basis of the reference information stored in the memory and the measurement result.

The reference object is configured to be displaceable between a first position in the detection area and a second position out of the detection area, and to be located at the second position when the crossing gate is open and to be located at the first position when the crossing gate is closed. This makes it possible to suitably avoid obstruction of traffic in the railroad crossing by the reference object.

The laser radar device is disposed at a position higher than a position of a gate arm of the crossing gate that is closed,

the detection area is set such that the gate arm is located in the detection area when the crossing gate is closed, and

the reference object is the gate arm.

In the railroad crossing provided with the crossing gate, using a gate arm as the reference object as described above makes it possible to set the reference object, which does not obstruct traffic in the railroad crossing, without an additional object.

When the railroad crossing is provided with a plurality of crossing gates, using each of the crossing gates as the reference object makes it possible to further suitably determine a change in position or direction of the laser radar device.

The light receiver is configured to receive laser light reflected on a ground, and

the controller stores, in the memory, as second reference information, first information on a distance to the ground and an irradiation angle for the ground, or second information relating to the first information, and determines a change of at least one of a position or a direction of the laser radar device on the basis of the second reference information and the measurement result.

According to the above, even when the positional relationship between the reference object and the detection area or irradiation area of the laser radar device is identical before and after a change in position or direction of the laser radar device, it is possible to suitably prevent the change from not being detected.

The light receiver is configured to receive laser light reflected on a ground, and

the controller includes a memory that stores, as reference information, first information on a distance to the ground and an irradiation angle for the ground, or second information relating to the first information, and determines a change of at least one of a position or a direction of the laser radar device on the basis of the reference information stored in the memory and the measurement result.

As described above, the controller is configured to determine a change of at least one of the position or the direction of the laser radar device on the basis of the distance to the ground.

This makes it possible to suitably determine the change without additional object.

### BRIEF DESCRIPTION OF THE DRAWINGS

In the accompanying drawings:

FIG. 1 is a perspective view of a railroad crossing of a first embodiment;

FIG. 2 is a schematic diagram of a laser radar unit;

FIG. 3 is a plan view of the railroad crossing;

FIG. 4 is a front view of the railroad crossing;

FIG. 5 is a flowchart of obstacle detection processing executed by a control section;

FIG. 6 is a schematic diagram of a specified range for detecting a gate arm;

FIG. 7 is a schematic diagram of a reference target;

FIG. 8 is a comparison chart between the laser unit and the reference target;

FIG. 9 is a flowchart of target setting processing executed by the control section;

FIG. 10 is a schematic diagram of a reference position for the reference target;

FIG. 11 is a flowchart of check processing executed by the control section;

FIGS. 12A, 12B, 12C, 12D and 12E are schematic diagrams illustrating how the position and the direction of the laser radar unit is checked;

FIGS. 13A and 13B are schematic diagrams of a railroad crossing obstacle detection system according to a second embodiment;

FIGS. 14A and 14B are schematic diagrams of a railroad crossing obstacle detection system according to a third embodiment;

FIG. 15 is a plan view of a railroad crossing;

FIG. 16 is a schematic diagram illustrating a check position;

FIGS. 17A and 17B are schematic diagrams illustrating how the position and the direction of the laser radar unit is checked;

FIGS. 18A and 18B are schematic diagrams illustrating how the position and the direction of the laser radar unit is checked;

FIGS. 19A and 19B are schematic diagrams of a railroad crossing obstacle detection system according to a fourth embodiment; and

FIGS. 20A, 20B, 20C, 20D, 20E and 20F are schematic diagrams of a railroad crossing obstacle detection system according to a fifth embodiment.

### DETAILED DESCRIPTION OF THE PREFERRED EMBODIMENTS

### First Embodiment

Hereinafter, a first embodiment is described with reference to drawings. The present embodiment embodies a railroad crossing obstacle detection system that detects an obstacle in a railroad crossing.

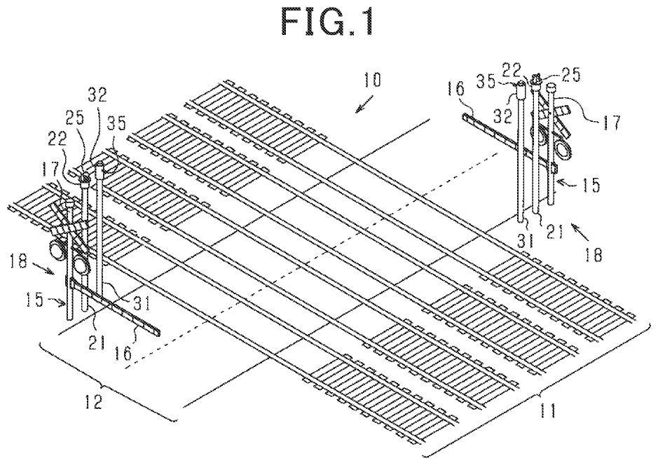

As illustrated in FIG. 1, a railroad crossing 10 includes a plurality of railroad tracks 11 and a plurality of road lanes 12 extending in a direction intersecting (crossing at a right angle) the railroad tracks 11. A crossing gate 15 is placed beside the railroad tracks 11. The crossing gate 15 includes a gate arm 16 serving as a gate opening and closing bar, and a railroad crossing warning pole 17 that rotatably holds the gate arm 16, and is disposed on each of the front side and the back side of the railroad crossing across the railroad tracks 11.

When a train passes by the railroad crossing 10, the gate arm 16 switches its position from a vertical position (open position) to a horizontal position (closed position) to shut off the road lanes 12. After the train passes by, the gate arm 16 switches its position from the horizontal position to the vertical position to cancel the shut-off of the road lanes 12. Hereinafter, the state of the crossing gate 15 in which the gate arm 16 takes a vertical position is referred to as an “open state”, and the state of the crossing gate 15 in which the gate arm 16 takes a horizontal position is referred to as a “closed state”.

A railroad crossing obstacle detection system 18 is applied to the railroad crossing 10, the railroad crossing obstacle detection system 18 being configured to detect an obstacle (e.g., a vehicle or a human) that blocks the travel of a train, when the crossing gate 15 is closed. When detecting an obstacle by the railroad crossing obstacle detection system 18, a train traveling toward the railroad crossing 10 or a control center of the railroad tracks is notified of the detection result.

The railroad crossing obstacle detection system 18 includes a laser radar unit 25 that applies laser light to an area (detection area) of the railroad crossing 10 in which obstacle detection is performed, and a controller that controls the laser radar unit 25. The laser radar unit 25 is attached to a support pole 21 for the laser radar unit. The support pole 21 for the laser radar unit is disposed near the crossing gate 15, specifically at a position closer to a center of the railroad crossing 10 than the crossing gate 15 is, and is arranged together with the crossing gate 15 along the road lanes 12. The laser radar unit 25 of the present embodiment is disposed above the gate arm 16 taking a horizontal position, and in detail, at a high position about 3 m from a ground G. The laser radar unit 25 disposed at a high position realizes a configuration for being less likely to be influenced by snow coverage, splashes of mud, or the like than the laser radar unit 25 disposed at a low position. The laser radar unit 25 disposed at a high position is also preferred to prevent vandalism of the laser radar unit 25.

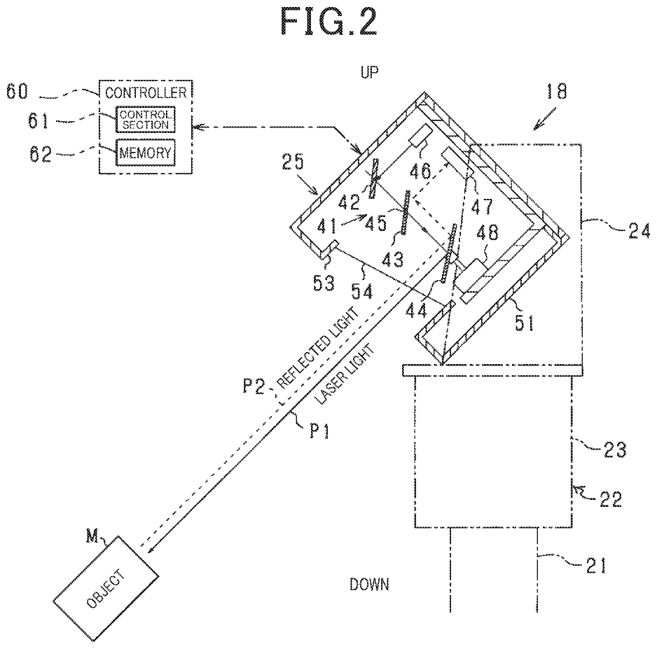

The support pole 21 for the laser radar unit has a total length greater than the length of the railroad crossing warning pole 17 of the gate arm 16, and the tip (upper end) of the support pole 21 projects above the railroad crossing warning pole 17. The laser radar unit 25 is fixed via a bracket 22 to the tip. As illustrated in FIG. 2, the bracket 22 includes a base 23 fixed to the support pole 21 for the laser radar unit using a fixture such as a bolt, and arms 24 that form a pair and stand upward from the base 23. The arms 24 hold the laser radar unit 25 that is inclined obliquely downward (directed to the ground G of the road lanes 12). The laser radar unit 25 is located above the detection area in the railroad crossing 10 and applies laser light from obliquely above to the detection area.

The laser radar unit 25 includes an optical mechanism 41 that outputs laser light at irradiation angles set every prescribed angle (e.g., 0.25°) and receives the laser light (hereinafter, referred to as reflected light) reflected on an object M, and a housing 51 that constitutes the outline of the laser radar unit 25. An irradiation opening 53 for the laser light is formed in the housing 51, and the housing 51 is placed such that the irradiation opening 53 is directed toward the road lanes 12. A window 54 that is transparent is fit in the irradiation opening 53, and the laser light from the optical mechanism 41 is applied to the detection area through the window 54.

The optical mechanism 41 includes a first fixed mirror 42, a second fixed mirror 43, a rotary mirror 44, a light emitter 46, and a light receiver 47. A through hole 45 is formed in a central portion of the second fixed mirror 43. The rotary mirror 44 is configured to be rotatable while maintaining a constant inclination angle with respect to the laser light reflected from the first fixed mirror 42. Specifically, the rotary mirror 44 is pivotally supported by a motor 48 (e.g., a stepper motor) fixed to the housing 51 so as to be rotatable, and the motor 48 rotates (rotationally moves) the rotary mirror 44 toward a prescribed scan direction in units of a prescribed angle. The axis of this rotation is obliquely inclined with respect to the ground G.

The laser light output from the light emitter 46 is first reflected on the first fixed mirror 42, passes through the through hole 45, is reflected on the rotary mirror 44, and then is applied to the detection area through the window 54. Thus, the first fixed mirror 42 and the rotary mirror 44 form a light path P1 for guiding the laser light output from the light emitter 46 to the detection area.

When an object M of some kind is present on the light path P1 of the laser light applied to the detection area, the laser light is reflected on the object M. The reflected light from the object M enters into the laser radar unit 25 through the window 54, and is reflected on the rotary mirror 44 and the second fixed mirror 43. Then, the reflected light from the second fixed mirror 43 is received by the light receiver 47. Thus, the rotary mirror 44 and the second fixed mirror 43 form a light path P2 for guiding the reflected light from the object M to the light receiver 47.

The light receiver 47 is configured to be capable of detecting the intensity of the reflected light and contributes to identify the reflected light from a reference target (reflector) described later from other reflected light.

The laser radar unit 25 includes a drive circuit for the optical mechanism 41 (the motor 48, the light emitter 46, and the light receiver 47). The drive circuit is connected to a controller 60, and the laser radar unit 25 controls the optical mechanism 41 on the basis of a command or the like from the controller 60, and sends information on a distance measurement result and an irradiation angle to the controller 60.

The controller 60 includes a control section 61 and a memory 62. The memory 62 stores a laser radar control program and various measurement results acquired from the laser radar unit 25. In addition, the control section 61, for example, determines the presence or absence of an object M and calculates the distance to the object M on the basis of the measurement results and the like stored in the memory 62. The controller 60 also includes, in addition to the control section 61 and the memory 62, a notifier that performs notification, for example, when an object is detected in the detection area or when a device generates an error, and an operation section that is operated by a user when initial setting (described later) and the like are performed. For example, the control section 61 may be a CPU (Central Processing Unit) or a MPU (Micro Processing Unit). The memory 62 may be a ROM (Read Only Memory) or a RAM (Random Access Memory).

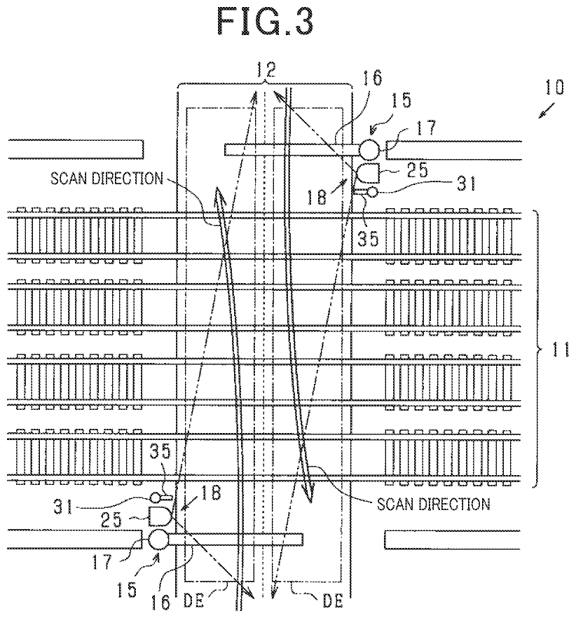

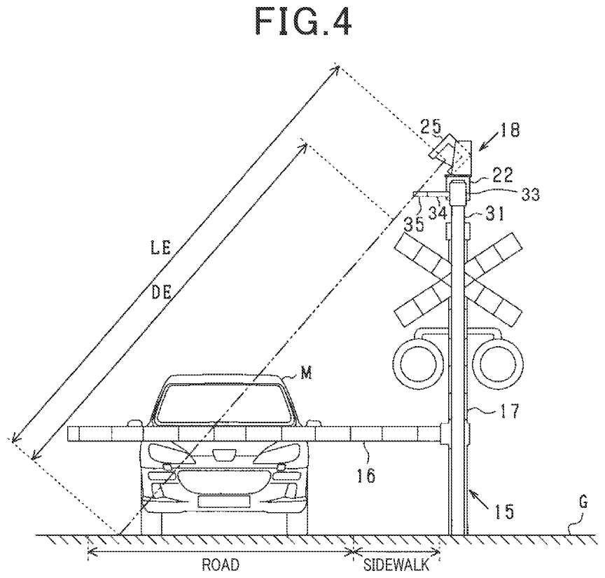

Here, the relationship between an irradiation area LE of laser light and a detection area DE is described with reference to FIGS. 3 and 4. The laser radar unit 25 outputs laser light to the ground G of a road 12, in detail a vehicle road, closest to the laser radar unit 25 between the road lanes 12 in both directions. That is, when there is not an obstacle or the like on the vehicle road, the laser light applied through the detection area DE without being blocked is reflected on the ground G of the road 12 (vehicle road) and part of the laser light reflected on the ground G reaches the light receiver 47. That is, the ground G defines a part of the outer edge of the detection area DE, and the laser radar unit 25 is capable of detecting the ground G.

As described above, the laser radar unit 25 is of a scan type, and outputs laser light at irradiation angles (ANG1 to ANG600) set every prescribed angle (0.25°) described above. The irradiation area LE crosses the railroad crossing 10, and not only covers the area in the railroad crossing 10 but also extends over each of the crossing gates 15 to the outside to the railroad crossing 10. In each of scan cycles, the irradiation angle of the laser light shifts from one (closest) crossing-gate-15 side to the other (furthest) crossing-gate-15 side. A part (e.g., ANG100 to ANG580) of the irradiation area LE corresponds to the detection area DE, and the detection area DE also crosses the railroad crossing 10. On the basis of the distance to an object having reflected the laser light, and the irradiation angle for the object, it is determined whether the object is an obstacle present in the detection area DE. In other words, the controller 60 sets the detection area DE in the program in conformity with the actual detection area that is proper in the railroad crossing 10.

In the present embodiment, the vicinity of the laser radar unit 25 is excluded from the detection area DE. The detection area DE is defined so as to be a diagonal line segment extending from the ground G to a position on the front side of the laser radar unit 25 when the railroad crossing 10 is viewed in the direction of the road lanes 12 and so as to be substantially quadrangular in the plan view of the railroad crossing 10. The reference target described later is disposed in the excluded area.

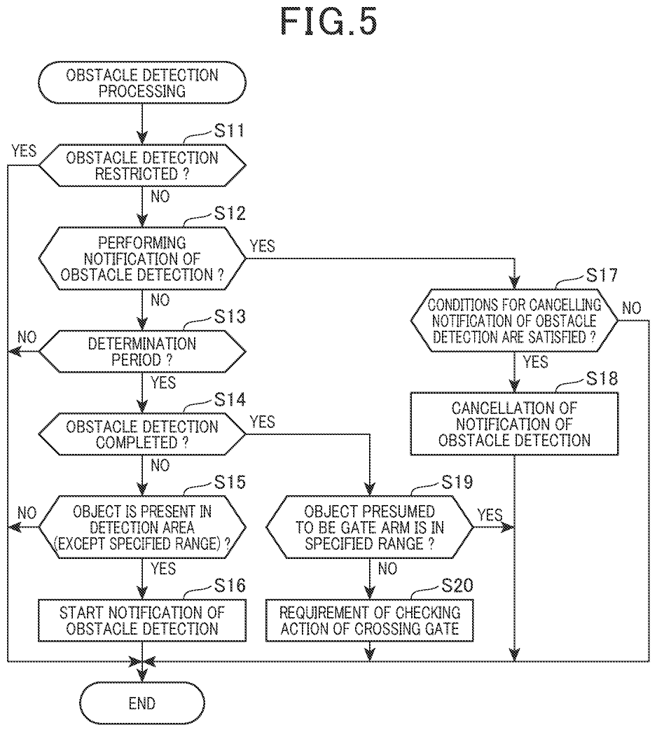

Next, the processing executed by the control section 61 of the controller 60 is described. This processing includes main processing and obstacle detection processing. The main processing includes causing the light emitter 46 output laser light at the irradiation angles (ANG1 to ANG600) set every prescribed angle described above, checking the state of receiving light by the light receiver 47 per irradiation angle, and storing information on the state of receiving light. The obstacle detection processing includes determining whether an obstacle or the like is present in the detection area DE on the basis of the information stored in the main processing. The main processing is processing executed during a scan, and the obstacle detection processing is processing repetitively executed every scan cycle. Here, the obstacle detection processing is described with reference to the flowchart of FIG. 5. The obstacle detection processing is processing executed in a period from when the gate arm 16 is closed until the conditions for returning the gate arm 16 to the open position are satisfied, and after a lapse of a prescribed stand-by time (e.g., 5 seconds).

In the obstacle detection processing, first, it is determined in step S11 whether the obstacle detection is restricted. When the obstacle detection is restricted, the present obstacle detection processing is terminated without further procedure. When the obstacle detection is not restricted, the processing continues to step S12 in which it is determined whether notification of obstacle detection is being performed. When the notification is not being performed, the processing continues to step S13 in which it is determined whether the processing is in a determination period, i.e., a period from the completion of application of laser light until the start of next application. When being not in the determination period, the present obstacle detection processing is terminated without further procedure. When being in the determination period, it is determined in step S14 whether the obstacle detection has been completed. When the obstacle detection has not been completed, the processing continues to step S15 in which it is determined whether an object (obstacle) is present in the detection area DE (excluding a specified range BE described later). When an object is present, the notification of obstacle detection is started in step S16 and then the present obstacle detection processing is terminated. By the notification of obstacle detection, the information that an obstacle has been detected is sent to a train or the like.

Back to step S12, when the notification of obstacle detection is being performed, the processing continues to step S17 in which it is determined whether the conditions for canceling the notification have been satisfied. When the determination is negative in step S17, the present obstacle detection processing is terminated without further processing. When a train driver or the like has performed a cancel operation after checking the railroad crossing 10, the cancellation conditions are satisfied, the notification of obstacle detection is canceled in step S18, and then the present obstacle detection processing is terminated.

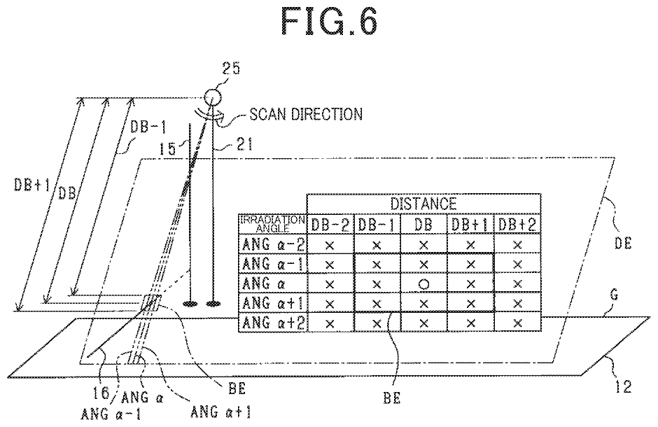

Back to step S14, when the determination is positive in step S14, that is, when the obstacle detection is completed, the processing continues to step S19. In step S19, it is determined whether an object presumed to be the gate arm 16 is present in the specified range BE of the detection area DE. Here, with reference to the schematic diagram of FIG. 6, the relationship between the detection area DE and the specified range BE is described. As heretofore described, the detection area DE of the present embodiment is set so as to intersect the gate arm 16 disposed to take a closed position, and the laser light reflected on the gate arm 16 reaches the light receiver 47. That is, the controller 60 is capable of capturing the gate arm 16 on the basis of the measurement result by the laser radar unit 25. One portion of the detection area DE is defined as the specified range BE (corresponding to the “gate arm information”) that is a position in which the gate arm 16 is to be detected when the laser radar unit 25 is not changed in position or direction and the gate arm 16 does not have deformation or the like. The specified range BE is out of the area to be detected for an obstacle.

The specified range BE is set to a range defined by an irradiation angle of laser light ANG α≠1 and a distance from the laser radar unit 25 DB±1. When an object is detected in the specified range BE and no object is detected around the specified range BE, the gate arm 16 is presumed to be located in the specified range BE. It takes some time for the gate arm 16 to stop vertical swings after being disposed to take a closed position. The stand-by time set in executing the obstacle detection processing in the present embodiment is a time set in consideration of the time taken to stop the swings.

When the determination is positive in step S19, the present obstacle detection processing is terminated without further procedure. When the determination is negative in step S19, the control section 61 requires a control center or the like to check the action of the crossing gate 15 and then terminates the present obstacle detection processing. That is, when the gate arm 16 is supposed to be disposed to take a closed position but is not actually disposed to take a closed position, the controller 60 recognizes the situation and informs a control center or the like of the situation.

Here, the laser radar unit 25 is disposed at a high position using the support pole 21 for the laser radar unit. Therefore, if the support pole 21 for the laser radar unit, or the like is deformed due to an influence of strong wind, earthquake, or the like, the laser radar unit 25 can be greatly changed in position or direction. When such a change is great, the detection area DE can probably be out of the proper area, causing trouble in exhibiting the obstacle detection function. That is, disposing the laser radar unit 25 at a high position is advantageous to prevent influence of snow coverage or the like, but causes a new problem preventing increase of the reliability. In order to solve this problem, the railroad crossing obstacle detection system 18 according to the present embodiment is configured to appropriately check (monitor) a change in position or direction of the laser radar unit 25 on the basis of the measurement result by the laser radar unit 25, and restrict the obstacle detection (see step S11) when the change exceeds an acceptable range. That is, the railroad crossing obstacle detection system 18 has a self-check function. Hereinafter, the configuration for checking the change in position and direction of the laser radar unit 25 is described.

As illustrated in FIG. 1, a support pole 31 for the reference target is disposed at a position on the central side of the railroad crossing 10 with respect to the laser radar unit 25 so as to be side-by-side with the support pole 21 for the laser radar unit. That is, the crossing gate 15, the support pole 21 for the laser radar unit, and the support pole 31 for the reference target are arranged in line along the road lanes 12.

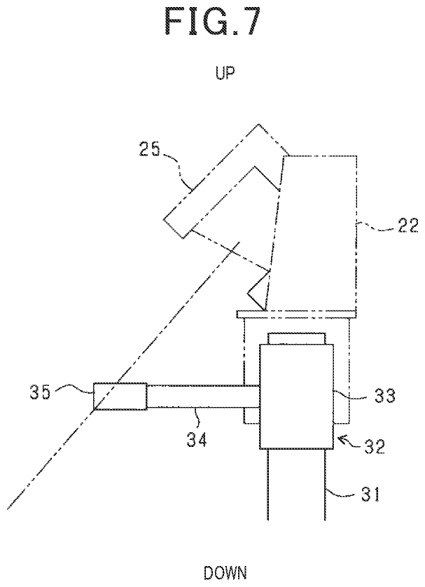

As illustrated in FIG. 7, the support pole 31 for the reference target has a total length slightly smaller than the total length of the support pole 21 for the laser radar unit, and a reference target 35 is attached via a bracket 32 to the tip (upper end) of the support pole 31. The bracket 32 includes a base 33 that has an annular shape and is fixed to the support pole 31 for the reference target using a fixture such as a bolt, and a projection 34 that projects from the base 33 in the radial direction of the support pole 31 for the reference target, specifically toward the road lanes 12. The projection 34 that has a bar shape is formed such that the tip thereof is located in the irradiation area LE of laser light applied from the laser radar unit 25.

The reference target 35, i.e., a highly reflective member (reflector) that reflects the laser light, is disposed at the tip of the projection 34. That is, the reference target 35 is disposed around the laser radar unit 25 and located in the irradiation area LE, but is out of the detection area DE (see FIGS. 3 and 4).

When the laser radar unit 25 is configured to apply laser light from above to the detection area DE, disposing the reference target 35 at a position lower than the position of the laser radar unit 25 can prevent useless widening of the irradiation area LE. Compared to disposing the reference target 35 at a low position, disposing the reference target 35 around (near) the laser radar unit 25, that is, at a high position, can make the railroad crossing obstacle detection system 18 less likely to suffer inconvenience such as inhibition of the application of laser light to the reference target 35 due to external factors such as snow coverage. In addition, disposing the reference target 35 close to the laser radar unit 25 is preferred to prevent the inhibition of transmission of laser light from application through reflection to reception between the reference target 35 and the laser radar unit 25.

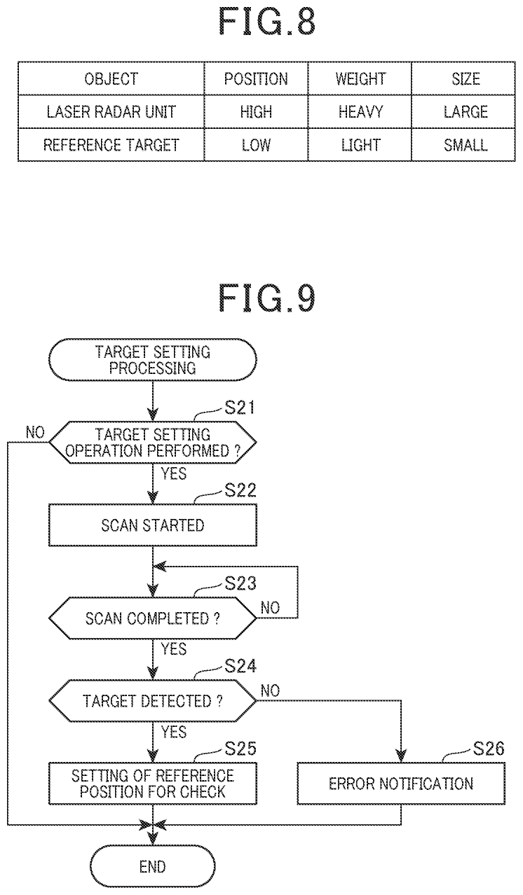

The support pole 21 for the laser radar unit and the support pole 31 for the reference target are disposed at positions close to each other. Therefore, one of the support poles is influenced by strong wind or the like, the other is also influenced by strong wind or the like. When the support pole 21 for the laser radar unit and the support pole 31 for the reference target are similarly deformed due to such an influence, but the positional relationship between the detection area or the irradiation area of the laser radar unit 25 and the reference target 35 is identical before and after the deformation in spite of the fact that the laser radar unit 25 is changed in position or direction, the change might possibly not be detected. This phenomenon causes a decrease of the reliability in the function of checking the position or the direction of the laser radar unit 25, and is thus not preferred. In this regard, in the present embodiment, the support poles 21 and 31 are different in total length but identical in thickness and strength, whereas the laser radar unit 25 and the reference target 35 are different in position, weight, and size (see FIG. 8) when compared to each other. In detail, the laser radar unit 25 is more susceptible to such an influence from the viewpoint of any of the position, the weight, and the size. Therefore, even when the same wind blows to the laser radar unit 25 and the reference target 35, the degree of the influence is less likely to be identical between them.

The railroad crossing obstacle detection system 18 according to the present embodiment is configured to go into an initial setting mode for performing initial setting in which the position of the reference target 35 is stored in the memory 62 of the controller 60, when the installation of the railroad crossing obstacle detection system 18 is completed and the controller 60 is switched to a power-on state. Hereinafter, with reference to the flowchart of FIG. 9, the processing of the initial setting mode (target setting processing) executed by the control section 61 of the controller 60 is described.

In the target setting processing, first, it is determined in step S21 whether a target setting operation has been performed by a worker. That is, it is determined whether a setting button (operation section) has been operated together with the switch-on operation. When the setting button operation has not been performed, the present target setting processing is terminated. When the setting button operation has been performed, the processing continues to step S22 in which a scan with laser light is started. In subsequent step S23, it is determined whether the scan has been completed. When the scan has been completed, the processing continues to step S24.

In step S24, it is determined whether the reference target 35 is located in an initial setting range that has been set in advance, on the basis of the distance measurement result acquired by the scan and the irradiating angle for the measured distance. When the reference target 35 cannot be detected, that is, when the position of the reference target 35 is out of the initial setting range, error notification is performed in step S26 and resetting is suggested. When the reference target 35 can be detected, the processing continues to step S25 in which a reference position SE (corresponding to the “reference information”) for check is stored in the memory 62. After this procedure, when the reference position SE stored coincides with the presumed position of the reference target 35, the laser radar unit 25 is determined not to be changed in position or direction, or the degree of the change is determined to be in an acceptable range. When the reference position SE stored does not coincide with the presumed position of the reference target 35, the change in position or direction of the laser radar unit 25 is determined to exceed the acceptable range.

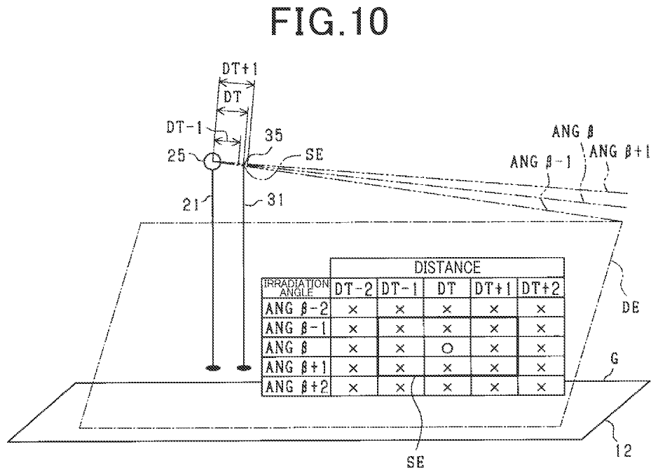

Here, with reference to FIG. 10, the relationship among the irradiation area LE of laser light, the detection area DE, the reference position SE, initial setting range of the reference position SE is described.

The length of each of the support poles 21 and 31 and the placement positions of both the support poles 21 and 31 are set such that the reference position SE is included in the irradiation area LE but excluded from the detection area DE. The reference position SE is set at a position near the light path of laser light applied to an edge of the detection area DE in the scan direction. In other words, the reference position SE is set at a position near a light path of a laser light applied at end angle in a detection range (e.g. ANG100 to ANG580) which is a part of a scan cycle (e.g. ANG1 to ANG600). Here, the position near the light path is a position on the light path (e.g. ANG β−1) or a position adjacent to the light path which is outside of the detection area DE (e.g. ANG β or β+1). Setting the reference position SE to such a position prevents the reference target 35 from inhibiting the obstacle detection or inhibiting widening of the detection area DE even when the reference target 35 is disposed around the laser radar unit 25.

However, both the laser radar unit 25 and the reference target 35 are placed using the support poles 21 and 31 respectively, and therefore the positional relationship between the laser radar unit 25 and the reference target 35 might possibly be influenced by variation in work for placement and generate some error. In this regard, the initial setting range of the reference position SE according to the present embodiment is set to have some tolerance, and the initial setting narrows the initial setting range to determine the reference position SE. In the example illustrated in FIG. 10, the position of the reference target 35 is included in the initial setting range. By narrowing the initial setting range, the reference position SE is defined by an irradiation angle ANG β±1 and a distance DT±1 such that a small error is acceptable. Designing the reference position SE to have an acceptable error is optional.

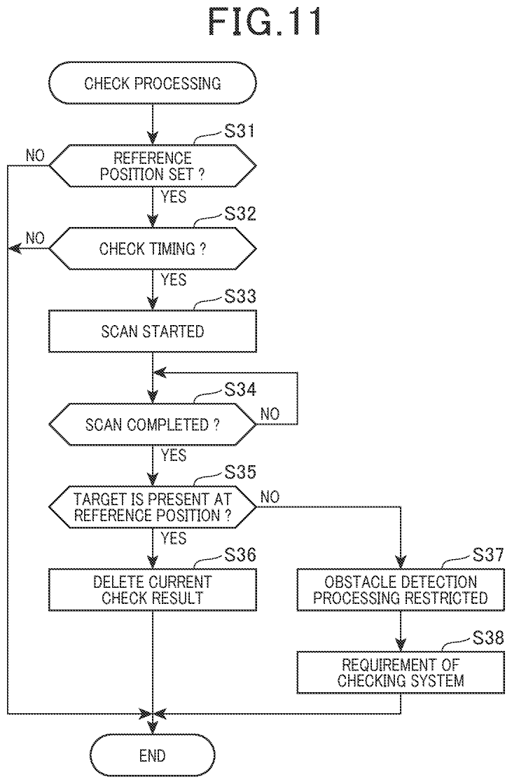

Next, with reference to the flowchart of FIG. 11, the processing of checking a change in position and direction of the laser radar unit 25 (check processing) executed by the control section 61 of the controller 60 is described. The check processing is processing executed to prepare the next obstacle detection when the crossing gate 15 is returned from the closed state to the open state, that is, after the obstacle detection is terminated. The specific timing of executing the present check processing is optional. For example, the control section 61 may be configured to execute the present check processing before the obstacle detection when the crossing gate 15 is switched from the open state to the closed state.

In the check processing, first, it is determined in step S31 whether the reference position SE is set. That is, it is determined whether the function of checking (monitoring) a change in position or direction of the laser radar unit 25 is effective. When the determination is negative in step S31, the present check processing is terminated without further procedure. When the determination is positive in step S31, the processing continues to step S32. In step S32, it is determined whether the check timing has come. When the crossing gate 15 is in the timing of returning from the closed state to the open state, a positive determination is made in step S32 and the processing continues to step S33. In step S33, the scan by the laser radar unit 25 is started. When the scan is completed, a positive determination is made in step S34 and the processing continues to step S35. In step S35, it is determined whether an object presumed to be the reference target 35 is located at the reference position SE stored in the memory 62. When the determination is positive in step S35, that is, when there is no change in position and direction of the laser radar unit 25 or when the change is in the acceptable range, the processing continues to step S36. In step S36, the current check result is deleted and the present check processing is terminated.

When an object presumed to be the reference target 35 is not located at the reference position SE, the control section 61 restricts the obstacle detection processing in step S37, requires a control center to check the railroad crossing obstacle detection system 18 in step S38, and then terminates the present check processing.

In the present embodiment, as illustrated in FIG. 10, when an object is detected at the reference position SE but no object is detected around the reference position SE, the reference target 35 is presumed to be located at the reference position SE.

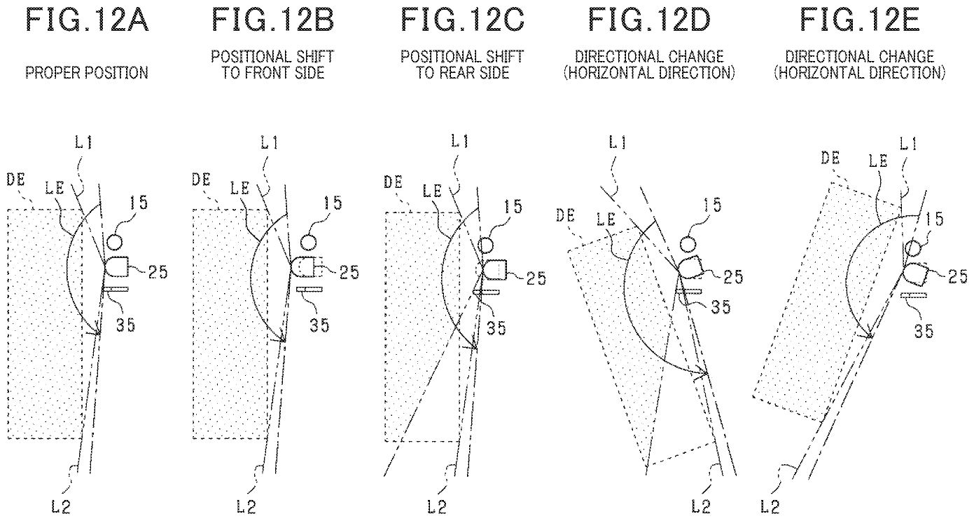

Next, with reference to FIG. 12A to 12E, changes of the relationship among the reference target 35, the irradiation area LE, and the detection area DE attributed to a change in position and direction of the laser radar unit 25 are described.

In the example illustrated from FIG. 12A to FIG. 12B, because the position of the laser radar unit 25 is shifted to the front side of the laser radar unit 25 (toward the road lanes 12), the reference target 35 is out of the reference position SE. This situation makes the control section 61 of the controller 60 determine a possibility that at least one of the position or the direction of the laser radar unit 25 is changed by an unacceptable level.

In the example illustrated from FIG. 12A to FIG. 12C, because the position of the laser radar unit 25 is shifted to the rear side of the laser radar unit 25, the reference target 35 is out of the reference position SE. The reference target 35 interrupts the light path of laser light applied to the detection area DE and greatly changes the shape of the detection area DE. This situation makes the control section 61 of the controller 60 determine a possibility that at least one of the position or the direction of the laser radar unit 25 is changed by an unacceptable level.

In the example illustrated from FIG. 12A to FIG. 12D, because the direction of the laser radar unit 25 is shifted in the horizontal direction (in detail, toward the reference target 35), the reference target 35 is out of the reference position SE. The reference target 35 interrupts the light path of laser light applied to the detection area DE and greatly changes the shape of the detection area DE. This situation makes the control section 61 of the controller 60 determine a possibility that at least one of the position or the direction of the laser radar unit 25 is changed by an unacceptable level.

In the example illustrated from FIG. 12A to FIG. 12E, because the direction of the laser radar unit 25 is shifted in the horizontal direction (in detail, toward the crossing gate 15), the reference target 35 is out of the reference position SE. This situation makes the control section 61 of the controller 60 determine a possibility that at least one of the position or the direction of the laser radar unit 25 is changed by an unacceptable level.

The first embodiment described above in detail exhibits the following excellent effects.

The laser radar unit 25 (corresponding to the “laser radar device”) configured to be disposed at a high position using the support pole 21 (corresponding to the “support object”) and apply laser light from above to the detection area DE is more advantageous than the laser radar unit 25 configured to be disposed at a low position close to the ground G and horizontally apply laser light, to prevent the light path of the laser light from being blocked due to an influence of weather or the like, that is, to prevent trouble in exhibiting the function of applying the laser light to the detection area DE.

On the other hand, the laser radar unit 25 that is disposed at a high position using the support pole 21 is highly likely to be changed in position or direction due to an influence of strong wind, earthquake, or the like, and there is a risk that a deviation of the irradiation area LE of laser light (easily make the irradiation region out of the proper position) may easily occur.

However, the railroad crossing obstacle detection system 18 according to the present embodiment monitors a change of at least one of the position or the direction of the laser radar unit 25 on the basis of the measurement result by the laser radar unit 25 and can thereby recognize, with a simple configuration, a situation in which the laser light cannot be applied to the proper position. That is, the railroad crossing obstacle detection system 18 is configured to apply laser light from above to the detection area DE and to monitor a change of at least one of the position or the direction of the laser radar unit 25, and can thereby suitably increase the reliability thereof.

The railroad crossing obstacle detection system 18 is configured to monitor a change of at least one of the position or the direction of the laser radar unit 25 using the reference target 35 (corresponding to the “reference object”) disposed in the irradiation area LE of laser light. The railroad crossing obstacle detection system 18 can thereby realize a self-monitoring function with a simple configuration.

As illustrated in the present embodiment, the reference target 35 is disposed at a position adjacent to the light path of laser light applied to one edge of the detection area in a scan cycle (in other words, laser light applied at end angle in a detection range which is a part of a scan cycle), the position being outside of the detection area DE. Such a disposition can prevent the reference target 35 from inhibiting the obstacle detection or inhibiting widening of the detection area DE even when the reference target 35 is disposed around the laser radar unit 25.

Respectively disposing the laser radar unit 25 and the reference target 35 on the support poles 21 and 31 can prevent the reference target 35 from being changed in position following a change in position or the like of the laser radar unit 25 attributed to deformation of the support pole 21 for the laser radar unit. That is, such a disposition can reduce the opportunity of coincidently making the positional relationship between the laser radar unit 25 and the reference target 35 the same before and after deformation. In other words, this makes it possible that the positional relationship between the detection area or irradiation area of the laser radar unit 25 and the reference target 35 easily changes when the support pole 21 for the laser radar unit 25 deforms. Therefore, it is possible to prevent a change in position or direction of the laser radar unit 25 from not being detected.

### Second Embodiment

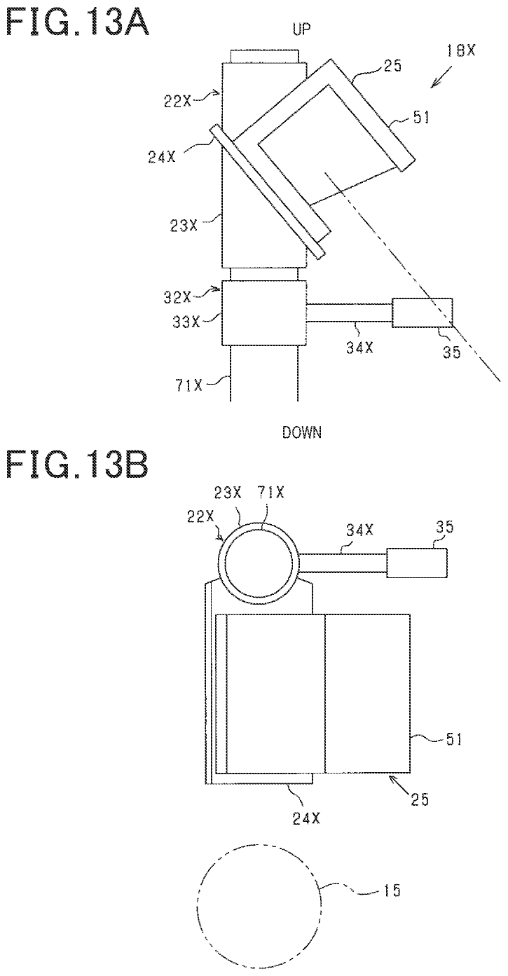

The present embodiment has, as one of its features, an idea of alleviating the application conditions of the railroad crossing obstacle detection system. Hereinafter, with reference to FIGS. 13A and 13B, a railroad crossing obstacle detection system 18X according to the present embodiment is described focusing on differences from the railroad crossing obstacle detection system 18 according to the first embodiment.

As illustrated in FIGS. 13A and 13B, the laser radar unit 25 and the reference target 35 are both attached to one support pole 71X. Specifically, the laser radar unit 25 is attached to the support pole 71X via a bracket 22X fixed at a position close to the tip (upper end) of the support pole 71X. The bracket 22X includes a base 23X that has an annular shape and is fixed to the support pole 71X using a fixture such as a bolt, and a projection 24X that projects from the base 23X in the radial direction of the support pole 71X. The projection 24X has a tabular shape obliquely inclined with respect to the ground, and the laser radar unit 25 is put on an upper surface of the projection 24X and fixed to the projection 24X using a fixture such as a bolt.

A bracket 32X is fixed to the support pole 71X at a position below the bracket 22X and is separate from the bracket 22X, and the reference target 35 is attached via the bracket 32X to the support pole 71X. The bracket 32X also includes a base 33X that has an annular shape and is fixed to the support pole 71X using a fixture such as a bolt, and a projection 34X that projects from the base 33X in the radial direction of the support pole 71X. The projection 34X has a bar shape, and the reference target 35 that is a reflector (highly reflective member) is disposed at the tip of the projection 34X.

The projection direction of the projection 24X of the bracket 22X is different from the projection direction of the projection 34X of the bracket 32X. Specifically, the projection direction of the projection 24X is the same direction as the direction of the road lanes 12 (see FIG. 1, etc.), whereas the projection direction of the projection 34X is the same direction as the direction of the railroad tracks 11 (see FIG. 1, etc.). Thus, the reference target 35 is located obliquely below the laser radar unit 25. The laser radar unit 25 is separate from the bracket 32X and the reference target 35, and the reference target 35 is also separate from the bracket 22X.

As described above in detail, collectively disposing the laser radar unit 25 and the reference target 35 on the one support pole 71X alleviates the constraints of space for placing the railroad crossing obstacle detection system 18X and makes the railroad crossing obstacle detection system 18X applicable to various railroad crossings.

The laser radar unit 25 and the reference target 35 are fixed to the support pole 71X using individual brackets 22X and 32X. This makes it possible to prevent the position of the reference target 35 from changing due to deforming of the brackets 22X even if the bracket 22X is deformed and the laser radar unit 25 is thus changed in position or direction. In other words, the laser radar unit 25 and the reference target 35 are respectively fixed to different brackets. This makes it possible to monitor a change in a position or direction of the laser radar unit 25 unless one of the brackets is deformed in the same way as the other.

In addition, even if the bracket 22X is deformed, inclining the laser radar unit 25 downward, the reference target 35 can be prevented from, for example, being pushed by the laser radar unit 25 and thus inclined downward like the laser radar unit 25. Such a configuration can therefore prevent the positional relationship between the detection area or the irradiation are of the laser radar unit 25 and the reference target 35 from being identical before and after deformation, and suitably reduce the risk of missing a change in position or direction of the laser radar unit 25. Further, the configuration for shifting the positions of the laser radar unit 25 and the reference target 35 in the peripheral direction of the support pole easily makes the laser radar unit 25 and the reference target 35 close to each other, compared to a configuration for distancing the laser radar unit 25 from the reference target 35 in the longitudinal direction of the support pole 71X to prevent mutual interference. The configuration is preferred to realize a configuration for disposing the reference target 35 near the laser radar unit 25.

The strength of the bracket 22X is lower than the strength of the support pole 71X, and the bracket 22X is considered to be deformed before the support pole 71X is deformed due to an influence of strong wind or the like. In addition, it is less likely that the bracket 22X is deformed in the same way as the bracket 32X. Such a configuration is therefore less likely to cause a phenomenon in which the laser radar unit 25 is changed in position or direction while maintaining the positional relationship between the detection area or irradiation area of the laser radar unit 25 and the reference target 35.

### Third Embodiment

The railroad crossing obstacle detection systems according to the first and second embodiments are configured to check (monitor) a change in position and direction of the laser radar unit 25 on the basis of the result of measuring the reference target 35 that is the reference object disposed in the irradiation area LE of laser light. In contrast, a railroad crossing obstacle detection system according to the present embodiment has a configuration different from the configurations of the first embodiment and the like in that the gate arm 16 of the crossing gate 15 is used as the reference object and the reference target 35 is not provided. Hereinafter, with reference to FIGS. 14A, 14B, 15, 16, 17A, 17B, 18A and 18B, a characteristic configuration of the present embodiment is described focusing on differences from the configurations of the first embodiment and the like.

As illustrated in FIG. 14A, when the crossing gate 15 is open, the gate arm 16 that maintains a vertical position is out of both the irradiation area LE of laser light and the detection area DE. That is, the laser light is not applied to the gate arm 16. In contrast, as illustrated in FIG. 14B, when the crossing gate 15 is closed and the obstacle detection is to be performed, the gate arm 16 taking a horizontal position is located in the irradiation area LE of laser light (in detail, the detection area DE). That is, the laser light is applied to the gate arm 16, and the laser light reflected on the gate arm 16 reaches the light receiver 47.

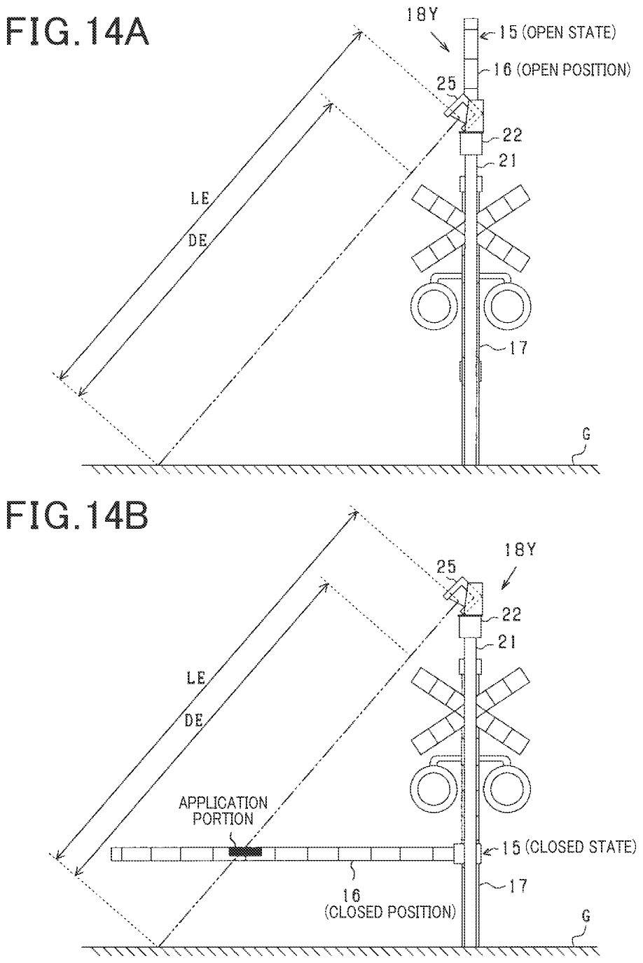

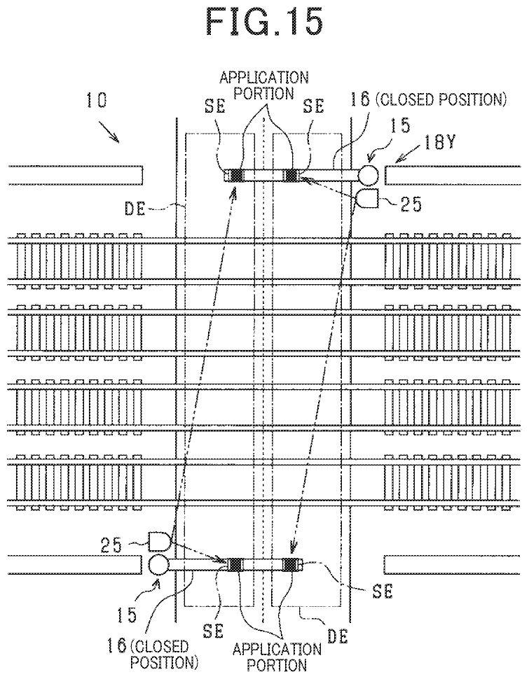

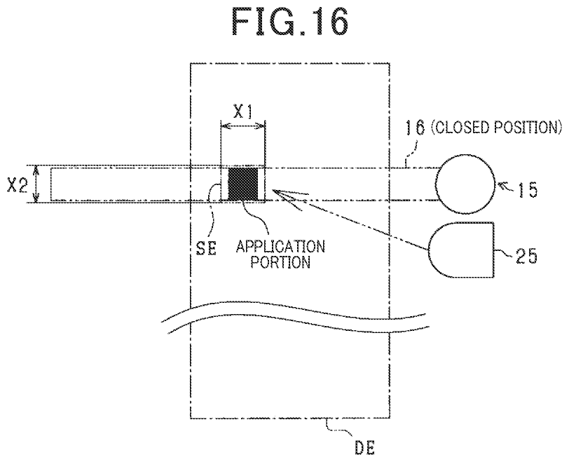

As illustrated in FIG. 15, the reference position SE is set at an intersecting portion between the detection area DE and each of the gate arms 16. That is, a part of the detection area DE is the reference position SE. Similarly, to the specified range BE described above, the reference position SE is defined so as to be a position including an intersecting portion between the detection area DE and each of the gate arms 16 when the gate arm 16 is not deformed and the laser radar unit 25 is not changed in position or direction. As illustrated in FIG. 16, the reference position SE is set so as to have a margin, for irradiation portion, larger in a longitudinal width X1 (the dimension in the width direction of the road lanes 12) than in a lateral width X2 (the dimension in the longitudinal direction of the road lanes 12), in consideration of vertical swings of the gate arm 16.

When having detected an object at the reference position SE but not detected an object at positions around the reference position SE, the controller 60 presumes that the gate arm 16 is located at the reference position SE.

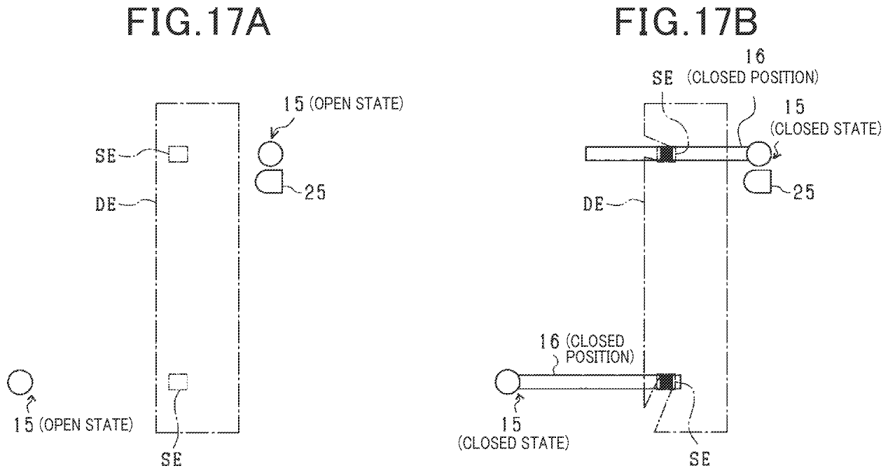

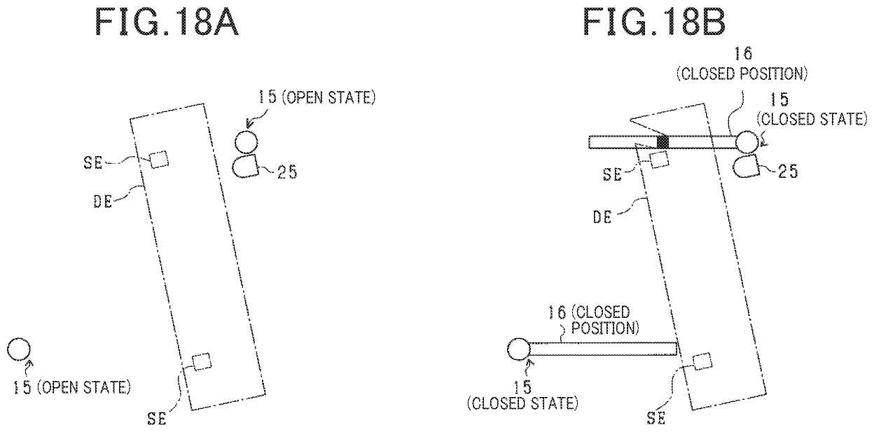

As illustrated from FIG. 17A to FIG. 17B, when the laser radar unit 25 is not changed in position or direction, the laser light is applied to the gate arm 16 disposed to take a closed position and the gate arm 16 is thus detected at the reference position SE. This situation makes the controller 60 determine that the laser radar unit 25 is not changed in position or direction. In contrast, when the laser radar unit 25 is changed in position or direction, the gate arm 16 detected is out of the reference position SE. This situation makes the controller 60 determine a shift in either position or direction of the laser radar unit 25. For example, in the example illustrated from FIG. 18A to FIG. 18B, the direction of the laser radar unit 25 is shifted in the horizontal direction. One of the gate arms 16 is detected in the detection area DE but is out of the reference position SE, and the other gate arm 16 is even out of the detection area DE. This measurement result makes the controller 60 determine that a shift of at least either one of the position or the direction of the laser radar unit 25 has occurred.

The gate arm 16 displaceable between the closed position (corresponding to the “first position”) in the detection area DE and the open position (corresponding to the “second position”) out of the detection area DE is used as the reference object. Such a use of the gate arm 16 enables the railroad crossing obstacle detection system to exhibit a self-monitoring function when the crossing gate 15 is closed while having a less complicated configuration. In addition, it is possible to suitably avoid obstruction of traffic by the reference object on the road lanes 12.

### Fourth Embodiment

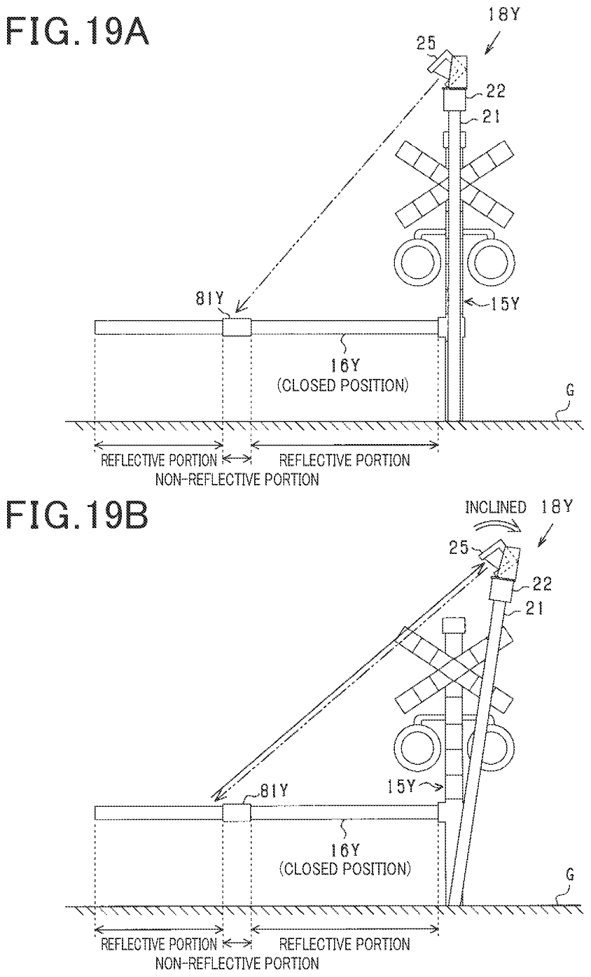

The railroad crossing obstacle detection system according to the third embodiment is configured to use the gate arm 16 as the reference object. In the present embodiment, the configuration involving the gate arm 16 is changed from the configuration of the third embodiment. Hereinafter, with reference to FIGS. 19A and 19B, a characteristic configuration of the present embodiment is described focusing on differences from the configuration of the third embodiment.

A gate arm 16Y includes a reflective portion (highly reflective portion) having a relatively high laser light reflectance, and a non-reflective portion (low reflective portion) having a relatively low laser light reflectance. Specifically, the reflective portion is configured to provide reflected laser light having an amount of light greater than a detection threshold detectable by the laser radar unit 25, and the non-reflective portion is configured to provide reflected laser light having an amount of light less than the detection threshold. That is, the gate arm 16Y is detectable or undetectable depending on the position to which the laser light is applied. In the present embodiment, in order to form the non-reflective portion by lowering the laser light reflectance thereof, a light absorber 81Y (e.g., a light absorbing tape) that absorbs light is disposed. The proportion of the reflective portion is greater than the proportion of the non-reflective portion in the gate arm 16Y.

The light absorber 81Y is disposed in a middle position of the gate arm 16Y, and both sides of the light absorber 81Y are reflective portions. In more detail, the light absorber 81Y is disposed at a position of the gate arm 16Y to which the laser light is applied in a situation in which the laser radar unit 25 is not changed in position and the gate arm 16Y does not have deformation or the like. Therefore, when neither the laser radar unit 25 nor the gate arm 16Y is shifted from a position set in advance, the laser light is absorbed by the light absorber 81Y and the detection of the gate arm 16Y is avoided. In contrast, when the laser radar unit 25 is changed in position or the like, the laser light is applied to the reflective portion. Thereby the reflecting object is presumed to be the gate arm 16Y from the measured result (shape, size, and position). As a result, the controller 60 determines a change in position or direction of the laser radar unit 25.

### Fifth Embodiment

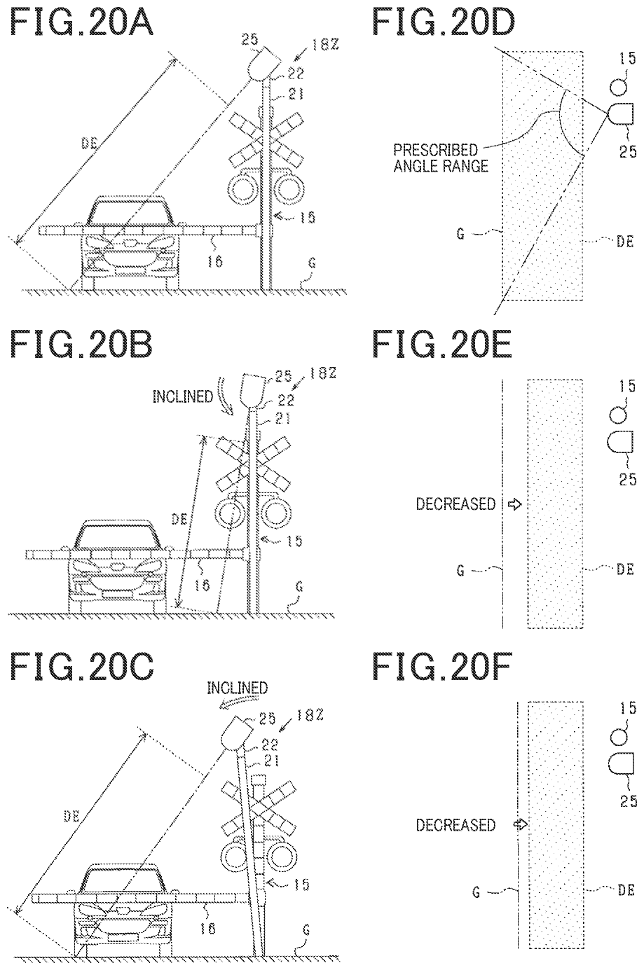

The railroad crossing obstacle detection systems according to the first to fourth embodiments are configured to check (monitor) a change in position or direction of the laser radar unit 25 using the reference object (the reference target 35 or the gate arm 16). The present embodiment has, one of its features, an advanced idea of preventing a change in position or direction of the laser radar unit 25 from not being detected. Hereinafter, with reference to FIG. 20A to 20F, a characteristic configuration of the present embodiment is described focusing on differences from the configurations of the first embodiment and the like. Features of the configuration in common with the features of the configurations of the first embodiment and the like are not described. In FIG. 20A to 20F, a component corresponding to the reference object is not illustrated for convenience.

In a configuration for monitoring a change in position or direction of the laser radar unit 25 using the reference object, when the laser radar unit 25 is changed in position or direction but the positional relationship between the detection area or the irradiation area the laser radar unit 25 and the reference object is identical before and after the change, it can be difficult to determine the change. Here, a railroad crossing obstacle detection system 18Z according to the present embodiment presumes the distance to the ground G from the measurement result by the laser radar unit 25, in detail, the linear distance from the laser radar unit 25 to a part on which the laser light has been reflected. Then, the railroad crossing obstacle detection system 18Z determines a change in position or direction of the laser radar unit 25 on the basis of the expected result and a reference distance (corresponding to the “second reference information”) stored in the memory 62 in advance. In monitoring of a change in position or direction of the laser radar unit 25, when the laser radar unit 25 is determined not to be changed in position or direction in monitoring with use of the reference object but determined to be changed in position or direction in monitoring with use of the ground G, it is required that an administrator or the like to check the system.

In snowy weather, the laser light reflected on the surface of snow can make it difficult to identify the reflecting object as either the ground G or the snow surface, and therefore the monitoring function using the ground is disabled.

When the bracket 22 of the laser radar unit 25 is deformed or the support pole 21 for the laser radar unit is deformed, thus changing the direction of the laser radar unit 25 upward or downward, the linear distance from the laser radar unit 25 to a part of the ground G on which the laser light is reflected is changed. Such a change is generated not only at a certain irradiation angle but also in the entire range (prescribed angle range) of the detection area DE. Thus, it is possible to distinguish between a change in the linear distance to the reflected object due to detecting an obstacle and the change due to a change in the position or the direction of the laser radar unit 25. That is, when an obstacle is detected, the distance to the reflecting object is changed at some of the irradiation angles, and the amount of the change is variable. In contrast, the direction of the laser radar unit 25 is changed, the distance to the reflecting object is changed similarly in the entire range (prescribed angle range) of the detection area DE. In the present embodiment, in consideration of dents on the rails of the railroad tracks 11, when the distance is changed similarly in 90% of the prescribed angle range, the laser radar unit 25 is determined to be changed in position or direction.

For example, as illustrated from FIG. 20A and FIG. 20B, when the bracket 22 is deformed, shifting the direction of the laser radar unit 25 downward, the distance to a part of the ground G on which the laser light is reflected is shortened. As a result, as illustrated from FIG. 20D and FIG. 20E, the detection area DE is decreased. When such a change in distance is generated, the laser radar unit 25 is determined to be changed in position or direction.

Further, as illustrated from FIG. 20A and FIG. 20C, when the support pole 21 for the laser radar unit is deformed, shifting the direction of the laser radar unit 25 downward and shifting the position of the laser radar unit 25 toward the road lanes 12, the distance to a part of the ground G on which the laser light is reflected is shortened. As a result, as illustrated from FIG. 20D and FIG. 20F, the detection area DE is decreased. When such a change in distance is generated, the laser radar unit 25 is determined to be changed in position or direction.

The railroad crossing obstacle detection system according to the fifth embodiment described above in detail can suitably prevent a change in position or direction of the laser radar unit 25 from being missed, even when the monitoring using the reference object is not functioning properly for incidental reasons.

The monitoring function using the ground G does not necessarily have to be combined with the monitoring function using the reference object illustrated in the first embodiment or the like, and the monitoring function using the reference object can be omitted.

### OTHER EMBODIMENTS

The railroad crossing obstacle detection system may be achieved, for example, as follows without being limited to the contents of the embodiments described above. The following configurations may be individually applied to the embodiments, or may be partially or entirely combined and applied to the embodiments. In addition, some or all of the various configurations illustrated in the embodiments can be combined in any way. In the combination, the technical meaning (exhibited effects) of each of the configurations to be combined is preferred to be secured.
The railroad crossing obstacle detection systems according to the embodiments are configured to determine a change in position or direction of the laser radar unit 25 on the basis of the positional relationship between the reference target 35 and the detection area or the irradiation area of the laser radar unit 25 (measurement result). This configuration, however, may be changed, and the railroad crossing obstacle detection system may be configured to determine a change in position or direction of the laser radar unit 25 on the basis of the shape or the size of the detection area DE.
The reference target 35 illustrated in the first embodiment and the like can be disposed between the crossing gate 15 and the laser radar unit 25. That is, the reference target 35 is disposed near the light path (light path L2) of laser light applied to a back-side end (further end) of the detection area DE in the scan direction. The reference target 35, however, can be disposed near the light path (light path L1) of laser light applied to a front-side end (near end) of the detection area DE in the scan direction. In other words, the reference target 35 may be disposed near the light path (light path L1) of laser light applied at start angle (e.g. ANG100) in a detection range (e.g. ANG100 to ANG 580) which is a part of the scan cycle (e.g. ANG1 to ANG600).

The number of reference targets is not limited to one, and a plurality of reference targets (e.g., two reference targets) can be used. When a plurality of reference targets are used, the reference targets may be respectively disposed, for example, near the light path L1 and near the light path L2.
In the first embodiment and the like, the gate arm 16 is located out of the irradiation area LE of laser light (in detail, out of the detection area DE) while the gate arm 16 is disposed to take an open position. This configuration, however, can be changed, and the gate arm 16 is located in the irradiation area LE (e.g., in the detection area DE) even while the gate arm 16 is disposed to take an open position. In such a configuration, the return of the gate arm 16 to the closed position is monitored, and also when the gate arm 16 is not returned to the closed position, it may be required that an administrator or the like to check the action of the crossing gate 15. Both the crossing gates 15 may not be set as a target whose action to be monitored by the railroad crossing obstacle detection system 18, and one (e.g., the closest crossing gate) of the crossing gates may be set as the target.
The laser radar unit 25 and the reference target 35 may be attached to the railroad crossing warning pole 17. However, when the railroad crossing warning pole 17 is integrated with the crossing gate 15 as illustrated in the first embodiment, the detection accuracy of the laser radar unit 25 may be lowered by swings caused when the crossing gate 15 is working. Therefore, in order to increase the detection accuracy, the crossing gate 15 is preferred to be placed separate from the laser radar unit 25 and the reference target 35.
In the first and second embodiments, the reference target 35 is disposed in the irradiation area LE of laser light but out of the detection area DE. The reference target 35, however, may be disposed in the irradiation area LE of laser light and in the detection area DE. However, in order to prevent confusion or the like of the reference target 35 with an obstacle or the like, it is technically significant to dispose the reference target 35 out of the detection area DE.
According to the third and fourth embodiments and the like, the gate arm 16 serving as the reference object moves from the open position to the closed position when the crossing gate 15 is switched from the open state to the closed state. Such a technical idea may be applied to the first or second embodiment, the technical idea including moving the reference object from a retraction position (corresponding to the “second position”) out of the detection area DE to a check position (corresponding to the “first position”) in the detection area DE when the crossing gate 15 is switched to the closed state. That is, the reference target 35 that is movable is moved from the retraction position to the check position when the crossing gate 15 is switched to the closed state and is moved from the check position to the retraction position when the crossing gate 15 is switched to the open state.
In the third and fourth embodiments, the gate arms 16Y of the plurality of crossing gates 15Y are used as the reference objects. However, only one (e.g., the nearer gate arm) of the gate arms may be used as the reference object.

The railroad crossing obstacle detection systems 18 according to the first and second embodiments are configured to monitor the actions of the plurality of crossing gates. However, the systems 18 may be configured to monitor the action of one crossing gate (e.g., the nearer crossing gate).
In the fourth embodiment, the light absorber 81Y is disposed at a portion of the gate arm 16Y to which the laser light from the laser radar unit 25 is applied when the gate arm 16Y is disposed to take a closed position (stationary), the laser radar unit 25 maintaining its position and direction as it is placed. The application portion is defined as non-reflective portion in which the reflection of the laser light is prevented, and the other portions of the gate arm 16Y are defined as reflective portions that reflect the laser light. In order to discriminate the application portion from the other portions, however, the relationship between the reflective portions and the non-reflective portion may be changed as follows. That is, a light reflective member such as a reflector can be disposed at a portion of the gate arm 16Y to which the laser light is applied when the gate arm 16Y is disposed to take a closed position (stationary), with the laser radar unit 25 having the proper position and direction, and a light absorber is disposed at the other portions. This makes it possible that the application portion is defined as the reflective portion and the other portions are defined as the non-reflective portions.
The railroad crossing obstacle detection systems 18 according to the embodiments can be applied as a detection system that detects, for example, an attempted suicide by train inside a station, or as a detection system that detects intrusion into a building or the like.
In the embodiments, the laser radar unit 25 is placed beside the railroad tracks, but may be placed between railroad tracks. In such placement, the reference target 35 may be placed between other railroad tracks or at a position between the same railroad tracks but on the other side across the road lanes 12.
The laser radar unit 25 of the embodiments is configured to apply laser light mainly to the vehicle road of the road lanes 12, but the laser radar unit 25 is not limited to this configuration. The laser radar unit 25 can be configured to apply laser light mainly to a sidewalk of the road lanes 12. In addition, the laser radar unit 25 may be replaced by a three-dimensional scan-type laser radar unit and configured to apply laser light to both the vehicle road and the sidewalk to enhance the monitoring function.

What is claimed is:

1. A railroad crossing obstacle detection system comprising:
a laser radar device that includes an irradiator and a light receiver, the irradiator applying laser light at irradiation angles set every prescribed angle, and the light receiver receiving the laser light reflected; and
a controller, wherein
the laser radar device is configured to be supported by a support object such that the laser radar device is located above a detection area of an obstacle in a railroad crossing, and to apply the laser light from above to the detection area, and
the controller is configured to:
detect an obstacle located in the detection area on the basis of a measurement result representing a distance to an object having reflected the laser light, and an irradiation angle for the object; and
monitor a change of at least one of a position or a direction of the laser radar device on the basis of the measurement result by the laser radar device.

2. The railroad crossing obstacle detection system according to claim 1, comprising a reference object disposed in an irradiation region of laser light, wherein
the controller includes a memory that stores, as reference information, information on a distance to the reference object and an irradiation angle for the reference object, or area information defined on the basis of the information, and determines a change of at least one of a position or a direction of the laser radar device on the basis of the reference information stored in the memory and the measurement result.

3. The railroad crossing obstacle detection system according to claim 2, wherein the reference object is disposed at a position around the laser radar device and lower than a position of the laser radar device.

4. The railroad crossing obstacle detection system according to claim 3, wherein
the laser radar device is configured to scan the irradiation region by applying a laser light to acquire the measurement result, and
the reference object is disposed at a position on a light path of a laser light applied at start angle or end angle in a detection range which is a part of a scan cycle or at a position adjacent to the light path, the laser light being applied in the scan cycle, and the position adjacent to the light path being outside of the detection area.

5. The railroad crossing obstacle detection system according to claim 2, wherein the reference object is disposed on an other support object different from the support object that supports the laser radar device.

6. The railroad crossing obstacle detection system according to claim 5, wherein
the detection area of the laser radar device extends along a road intersecting a railroad in the railroad crossing, and
both the support object and the other support object are poles that are disposed in to be mutually parallel along the road.

7. The railroad crossing obstacle detection system according to claim 2, wherein the reference object is attached to the support object that supports the laser radar device using an attachment different from an attachment for the laser radar device.

8. The railroad crossing obstacle detection system according to claim 7, wherein
the support object is a pole, and
the reference object and the laser radar device viewed in a longitudinal direction of the pole are positionally offset from each other in a peripheral direction of the pole.

9. The railroad crossing obstacle detection system according to claim 1, wherein
the railroad crossing is provided with a crossing gate, and the laser radar device is disposed at a position higher than a position of a gate arm of the crossing gate that is closed,
the detection area is set such that the gate arm is located in the detection area when the crossing gate is closed,
the memory stores, as gate arm information, first information on a distance to the gate arm and an irradiation angle for the gate arm when the crossing gate is closed, or second information relating to the first information, and
the controller monitors a motion of the gate arm on the basis of the gate arm information and the measurement result.

10. The railroad crossing obstacle detection system according to claim 1, comprising a reference object displaceable between a first position in the detection area and a second position out of the detection area, wherein
the reference object is located at the second position when a crossing gate of the railroad crossing is open, and the reference object is located at the first position when the crossing gate is closed, and
the controller includes a memory that stores, as reference information, first information on at least a distance to the reference object at the first position and an irradiation angle for the reference object, or second information relating to the first information, and determines a change of at least one of a position or a direction of the laser radar device on the basis of the reference information stored in the memory and the measurement result.

11. The railroad crossing obstacle detection system according to claim 10, wherein
the laser radar device is disposed at a position higher than a position of a gate arm of the crossing gate that is closed,
the detection area is set such that the gate arm is located in the detection area when the crossing gate is closed, and
the reference object is the gate arm.

12. The railroad crossing obstacle detection system according to claim 2, wherein
the light receiver is configured to receive laser light reflected on a ground, and
the controller stores, in the memory, as second reference information, first information on a distance to the ground and an irradiation angle for the ground, or second information relating to the first information, and determines a change of at least one of a position or a direction of the laser radar device on the basis of the second reference information and the measurement result.

13. The railroad crossing obstacle detection system according to claim 1, wherein
the light receiver is configured to receive laser light reflected on a ground, and
the controller includes a memory that stores, as reference information, first information on a distance to the ground and an irradiation angle for the ground, or second information relating to the first information, and determines a change of at least one of a position or a direction of the laser radar device on the basis of the reference information stored in the memory and the measurement result.
